(19) United States
(12) Patent Application Publication
(10) Pub. No.: US 2013/0279208 A1
(43) Pub. Date: Oct. 24, 2013

(54) POWER CONVERTER AND CONTROLLING METHOD

(71) Applicants: Yuan-Fang LAI, Taoyuan County (TW); Ying-Sung CHANG, Taoyuan County (TW)

(72) Inventors: Yuan-Fang LAI, Taoyuan County (TW); Ying-Sung CHANG, Taoyuan County (TW)

(73) Assignee: DELTA ELECTRONICS, INC., Taoyuan County (TW)

(21) Appl. No.: 13/611,711

(22) Filed: Sep. 12, 2012

(30) Foreign Application Priority Data
Apr. 23, 2012 (TW) 101114329

(51) Int. Cl. H02M 3/335

(52) U.S. Cl. 363/21.12

(57) ABSTRACT

A power converter and a method of controlling the same are disclosed. The power converter includes a transformer, a first switch unit, a second switch unit, and a control unit. The control unit turns on/off the first switch unit and the second switch unit according to magnitude of an input voltage. When the input voltage is at a high voltage range, the control unit turns on the first switch unit and turns off the second switch unit; when the input voltage is at a low voltage range, the control unit turns on the second switch unit and turns off the first switch unit. Accordingly, a turn ratio of the transformer is adaptively adjusted with variations of the input voltage, thus maintaining the power converter to be

[symbol]

This application is based on and claims the benefit of Taiwan Application No. 101114329 filed Apr. 23, 2012 the entire disclosure of which is incorporated by reference herein.

### BACKGROUND

1. Technical Field

The present disclosure relates generally to a power converter and a method of controlling the same, and more particularly to a power converter and a method of controlling the same are provided to maintain the power converter to be operated at a maximum duty cycle to provide optimal conversion efficiency by adaptively adjusting a turn ratio of a transformer.

2. Description of Related Art

Power converters are applied to convert energy for AC utility, battery, and so on. Also, the power converter needs to have a wide input voltage range when an input voltage of the external power source has a large voltage variation. However, the power converter usually has a poorer efficiency in processing middle voltage range of the input voltage when the power converter has a wide input voltage range. That is because turns and a turn ratio of a transformer of the power converter are determined according to the available range of the input voltage and the output voltage thereof. Especially, the corresponding duty cycle is reduced when the input voltage increases. For this reason, it is difficult to consider the efficiency at the rated input voltage when the input voltage of the external power source has a large voltage variation.

Reference is made to FIG. 1 which is a circuit diagram of a prior art fly-back converter. The fly-back converter is used as an auxiliary power and a turn ratio of a transformer thereof is N:1. Note that, a relation between the turn ratio, an input voltage, an output voltage, and a duty cycle is expressed as follows:

$$N = \frac{Vi}{Vo} \times \frac{D}{1 - D} \qquad ( formula 1 )$$

wherein, Vi is the input voltage, Vo is the output voltage, D is the duty cycle, and N is the turn ratio.

Further, the above-mentioned formula can be rewritten as:

$$D = \frac{1}{1 + \frac{1}{N} \times \frac{Vi}{Vo}} \qquad ( formula 2 )$$

In general, the turn ratio of the transformer is fixed once the fly-back converter is completely designed. Hence, in the formula 2, the corresponding duty cycle is reduced when the input voltage Vi increases. In addition, converters are usually operated nearby the rated voltage and operated at the maximum duty cycle to maintain the optimal conversion efficiency. The conversion efficiency is much poorer, however, once the input voltage is much higher than the lowest input voltage.

Accordingly, it is desirable to provide a power converter and a method of controlling the same to adaptively adjust the turn ratio of the transformer with variations of the input voltage, thus maintaining the power converter to be operated at a maximum duty cycle to provide optimal conversion efficiency.

### SUMMARY

Accordingly, the power converter includes a transformer, a first switch unit, at least one second switch unit, and a control unit. The transformer has a primary-side winding and a secondary-side winding, wherein the primary-side winding has a first terminal, a second terminal, and at least one tap terminal. The first switch unit has a first terminal and a second terminal, wherein the first terminal is electrically connected to the second terminal of the primary-side winding and an input voltage is electrically connected between the first terminal of the primary-side winding and the second terminal of the first switch unit. At least one second switch has a first terminal and a second terminal, wherein the first terminal is electrically connected to the tap terminal of the primary-side winding and the second terminal is electrically connected to the second terminal of the first switch unit. The control unit controls the first switch unit and the second switch unit according to magnitude of the input voltage.

Wherein the control unit is configured to turn on the first switch unit and to turn off at least one second switch unit when the input voltage is at a high voltage range; the control unit is configured to turn on at least one second switch unit and to turn off the first switch unit when the input voltage is at a low voltage range; whereby a turn ratio of the transformer is adaptively adjusted with variations of the input voltage.

Accordingly, the method includes the following steps: (a) a transformer is provided; the transformer has a primary-side winding and a secondary-side winding, wherein the primary-side winding has a first terminal, a second terminal, and at least one tap terminal; (b) a first switch unit is provided; the first switch unit has a first terminal and a second terminal, wherein the first terminal is electrically connected to the second terminal of the primary-side winding; an input voltage is electrically connected between the first terminal of the primary-side winding and the second terminal of the first switch unit; (c) at least one second switch unit is provided; at least one second switch unit has a first terminal and a second terminal, wherein the first terminal is electrically connected to the tap terminal of the primary-side winding and the second terminal is electrically connected to the second terminal of the first switch unit; (d) a control unit is provided; (e) the first switch unit is turned on and at least one second switch unit is turned off by the control unit when the input voltage is at a high voltage range; at least one second switch unit is turned on and the first switch unit is turned off by the control unit when the input voltage is at a low voltage range; whereby a turn ratio of the transformer is adaptively adjusted with variations of the input voltage.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWINGS

FIG. 1 is a circuit diagram of a prior art fly-back converter;

FIG. 2 is a circuit diagram of a power converter according to a first embodiment of the present invention;

FIG. 3 is a circuit diagram of the detailed embodiment in FIG. 2;

FIG. 4 is a circuit diagram of the power converter according to a second embodiment of the present invention; and

FIG. 5 is a flowchart of a method of controlling a power converter according to the present invention.

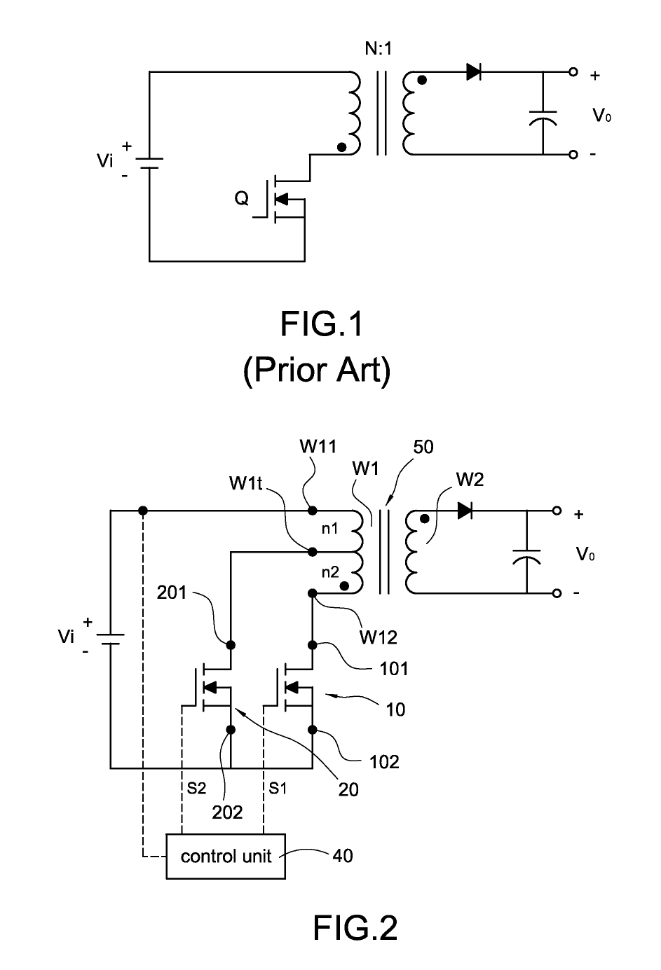

### DETAILED DESCRIPTION

Reference will now be made to the drawing figures to describe the present invention in detail.

Reference is made to FIG. 2 which is a circuit diagram of a power converter according to a first embodiment of the present invention. In this embodiment, a fly-back converter is exemplified for further demonstration. The power converter includes a transformer 50, a first switch unit 10, at least one second switch unit 20, and a control unit 40.

The transformer 50 has a primary-side winding w1 and a secondary-side winding w2, wherein the primary-side winding w1 has a first terminal w11, a second terminal w12, and at least one tap terminal w1t. The first switch unit 10 has first terminal 101 and a second terminal 102, wherein the first terminal 101 is electrically connected to the second terminal w12 of the primary-side winding w1; an input voltage Vi is electrically connected between the first terminal w11 of the primary-side winding w1 and the second terminal 102 of the first switch unit 10. At least one second switch unit 20 has a first terminal 201 and a second terminal 202, wherein the first terminal 201 is electrically connected to the tap terminal wlt of the primary-side winding and the second terminal 202 is electrically connected to the second terminal 102 of the first switch unit 10. Especially, the transformer 50 provides a full-turn-ratio conversion for the input voltage Vi by the first switch unit 10 and the transformer 50 provides a part-turn-ratio conversion for the input voltage Vi by the second switch unit 20. In this embodiment, the amount of the second switch unit 20 is equal to one. Further, the detailed description of controlling the first switch unit 10 and the second switch unit 20 will be made hereinafter.

The control unit 40 controls the first switch unit 10 and the second switch unit 20 according to magnitude of the input voltage Vi. In particular, the control unit 40 turns on the first switch unit 10 and turns off the second switch unit 20 when the input voltage Vi is at a high voltage range. In the other hand, the control unit 40 turns on the second switch unit 20 and turns off the first switch unit 10 when the input voltage Vi is at a low voltage range. Therefore, the first switch unit 10 and the second switch unit 20 are controlled by the control unit 40 to adaptively adjust a turn ratio of the transformer 50 with variations of the input voltage Vi, thus maintaining the power converter to be operated at a maximum duty cycle to provide optimal conversion efficiency.

With regard to operation of the power converter, two embodiments will be exemplified in detail for further demonstration. As shown in FIG. 2 again, it is assumed that the power converter has a first switch unit 10 and a second switch unit 20. Therefore, the transformer 50 provides a full-turn-ratio conversion for the input voltage Vi by the first switch unit 10 and provide a part-turn-ratio conversion for the input voltage Vi by the second switch unit 20. That is, the transformer 50 converts the input voltage Vi according to a proportion between a first turn value n1 and a second turn value n2 when total turns of the primary-side winding w1 are divided into the first turn value n1 and the second turn value n2 by the tap terminal w1t connected to the second switch unit 20. In other words, the control unit 40 turns on the first switch unit 10 and turns off the second switch unit 20 when the control unit 40 detects that the input voltage Vi is at a high voltage range so that the turn ratio between the primary-side winding w1 and the secondary-side winding w2 is equal to (n1+n2):1. Accordingly, a relation between the output voltage Vo and the input voltage Vi is:

$$Vo = Vi \times \frac{D}{1 - D} \times \frac{1}{n 1 + n 2} ; \qquad$$

wherein, D is a duty cycle;
Further, the above-mentioned formula can be rewritten as:

$$Vo \leq Vi \times \frac{Dmax}{1 - Dmax} \times \frac{1}{n 1 + n 2} ;$$

wherein, Dmax is a maximum of the duty cycle and D max≦0.5;

For convenient explanation, Dmax=0.5 is exemplified for further demonstration hereinafter. Hence, the above-mentioned formula can be further rewritten as:

$$Vo = \frac{Vi}{n 1 + n 2} ;$$

On the other hand, the control unit 40 turns on the second switch unit 20 and turns off the first switch unit 10 when the control unit 40 detects that the input voltage Vi is at a low voltage range so that the turn ratio between the primary-side winding w1 and the secondary-side winding w2 is equal to n1:1. Accordingly, a relation between the output voltage Vo and the input voltage Vi is:

$$Vo = \frac{Vi}{n 1} ;$$

Accordingly, the control unit 40 turns on/off the first switch unit 10 and the second switch unit 20 to adaptively adjust a turn ratio between the primary-side winding w1 and the secondary-side winding w2 of the transformer 50 when the power converter detects variations of the input voltage Vi, thus maintaining the power converter to be operated at a maximum duty cycle (refer to formula 2 in description of related art) to provide optimal conversion efficiency.

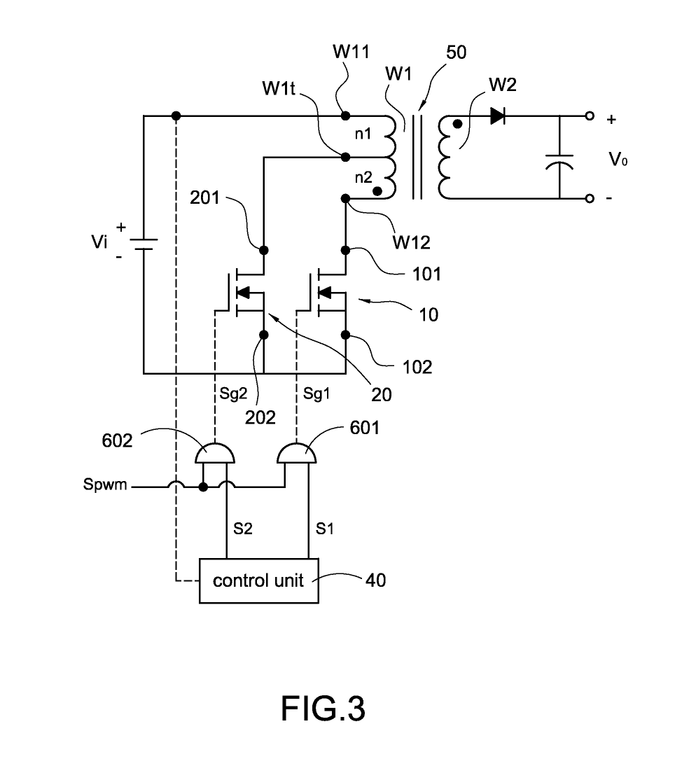

Reference is made to FIG. 3 which is a circuit diagram of the detailed embodiment in FIG. 2. Note that, the circuit components in the FIG. 3 are identical to those in the FIG. 2 except the control manners of the first switch unit 10 and the second switch unit 20 in the two circuits. As shown in FIG. 3, the first switch unit 10 and the second switch unit 20 are electrically connected to a first AND gate 601 and a second AND gate in series, respectively, but is not intended to limited scope of the invention. In particular, an input terminal of the first AND gate 601 and an input terminal of the second AND gate 602 are jointly connected to receive a pulse-width modulation (PWM) signal. Further, the other input terminal of the first AND gate 601 receives a first control signal S1 produced from the control unit 40; similarly, the other input terminal of the second AND gate 602 receives a second control signal S2 produced from the control unit 40. In this embodiment, the PWM signal is simultaneously provided to the first AND gate 601 and the second AND gate 602. When the control unit 40 detects that the input voltage Vi is at a high voltage range, the control unit 40 produces the high-level first control signal S1 and then outputs a high-level first gate control signal Sg1 from the first AND gate 601 to turn on the first switch unit 10 via a logical operation of the first AND gate 601. Simultaneously, the control unit 40 also produces the low-level second control signal S2 and then outputs a low-level second gate control signal Sg2 from the second AND gate 602 to turn off the second switch unit 20 via a logical operation of the second AND gate 602.

In addition, when the control unit 40 detects that the input voltage Vi is at a low voltage range, the control unit 40 produces the low-level first control signal S1 and then outputs the low-level first gate control signal Sg1 from the first AND gate 601 to turn off the first switch unit 10 via a logical operation of the first AND gate 601. Simultaneously, the control unit 40 also produces the high-level second control signal and then outputs the high-level second gate control signal Sg2 from the second AND gate 602 to turn on the second switch unit 20 via a logical operation of the second AND gate 602.

According to the above-mentioned formula 2 in the prior art description, the corresponding duty cycle D will also increase when the turn ratio N is increased so that the conversion efficiency of the power converter is also improved. Accordingly, the control unit 40 provides the high-level first control signal 51 and the low-level second control signal S2 when the input voltage Vi is at a high voltage range so that the transformer 50 provides a full-turn-ratio conversion for the input voltage Vi by the first switch unit 10, namely, the turn ratio between the primary-side winding w1 and the secondary-side winding w2 is equal to (n1+n2):1. However, the control unit 40 provides the low-level first control signal 51 and the high-level second control signal S2 in case of voltage reduction of the input voltage Vi to a low voltage range so that the transformer 50 provides a part-turn-ratio conversion for the input voltage Vi by the second switch unit 20, namely, the turn ratio between the primary-side winding w1 and the secondary-side winding w2 is equal to n1:1. Therefore, the sufficient secondary-side voltage can be provided to prevent the unstable output voltage Vo from sudden voltage drop of the input voltage Vi by reducing the turn ratio of the transformer 50, thus stabilizing the output voltage Vo.

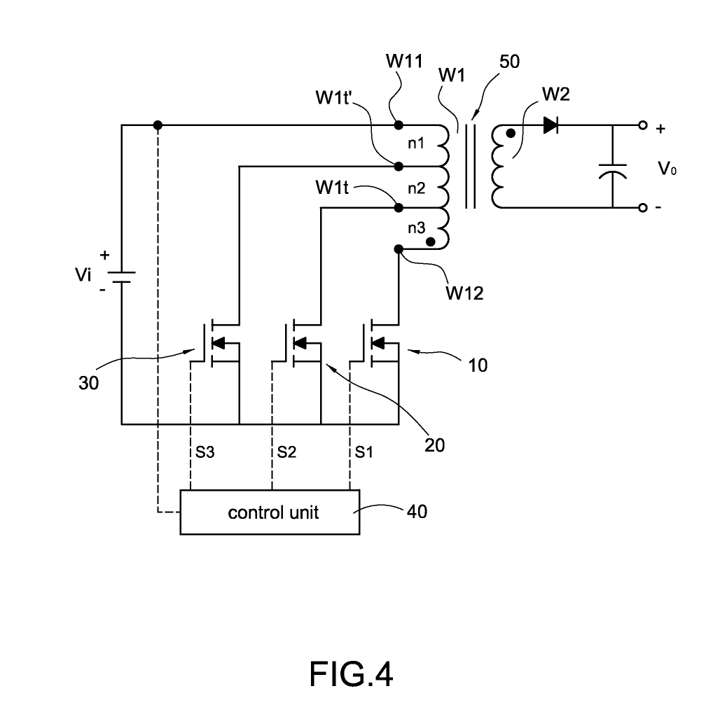

Reference is made to FIG. 4 which is a circuit diagram of the power converter according to a second embodiment of the present invention. It is assumed that the power converter has one the first switch unit 10 and two the second switch units which are referred to as the second switch unit 20 and a third switch unit 30, respectively. Therefore, the transformer 50 provides a full-turn-ratio conversion for the input voltage Vi by the first switch unit 10 and provide a part-turn-ratio conversion for the input voltage Vi by the second switch unit 20 and the third switch unit 30. That is, the transformer 50 converts the input voltage Vi according to a proportion between a first turn value n1, a second turn value n2, and a third turn value n3 when total turns of the primary-side winding w1 are divided into the first turn value n1, the second turn value n2, and the third turn value n3 by the tap terminal w1t connected to the second switch unit 20 and another tap terminal w1t′ connected to the third switch unit 30. In other words, the control unit 40 turns on the first switch unit 10 and turns off the second switch unit 20 and the third switch unit 30 when the control unit 40 detects that the input voltage Vi is at a high voltage range so that the turn ratio between the primary-side winding w1 and the secondary-side winding w2 is equal to (n1+n2+n3):1. Accordingly, a relation between the output voltage Vo and the input voltage Vi is:

$$Vo = \frac{Vi}{n 1 + n 2 + n 3} ;$$

Further, the control unit 40 turns on the second switch unit 20 and turns off the first switch unit 10 and the third switch unit 30 when the control unit 40 detects that the input voltage Vi is at a middle voltage range so that the turn ratio between the primary-side winding w1 and the secondary-side winding w2 is equal to (n1+n2):1. Accordingly, a relation between the output voltage Vo and the input voltage Vi is:

$$Vo = \frac{Vi}{n 1 + n 2} ;$$

On the other hand, the control unit 40 turns on the third switch unit 30 and turns off the first switch unit 10 and the second switch unit 20 when the control unit 40 detects that the input voltage Vi is at a low voltage range so that the turn ratio between the primary-side winding w1 and the secondary-side winding w2 is equal to n1:1. Accordingly, a relation between the output voltage Vo and the input voltage Vi is:

$$Vo = \frac{Vi}{n 1} ;$$

Accordingly, the control unit 40 turns on/off the first switch unit 10, the second switch unit 20, and the third switch unit 30 to adaptively adjust a turn ratio between the primary-side winding w1 and the secondary-side winding w2 of the transformer 50 when the power converter detects variations of the input voltage Vi, thus maintaining the power converter to be operated at a maximum duty cycle (refer to formula 2 in description of related art) to provide optimal conversion efficiency.

However, the above-mentioned two embodiments are only for ease of illustration, and more particularly to the amount of the second switch unit 20. Hence, the amount of the second switch unit 20 is determined according to practical application requirements of the power converter. Note that, if the amount of the second switch unit 20 increases, more precise voltage conversion ratios between the primary-side winding w1 and the secondary-side winding w2 can be provided, thus maintaining the power converter to be operated at a maximum duty cycle to provide optimal conversion efficiency based on variations of the input voltage Vi.

Especially, as with the first embodiment, the first switch unit 10, the second switch unit 20, and the third switch unit 30 are controlled by using logic gate control in this embodiment to adaptively adjust the turn ratio of between the primary-side winding w1 and the secondary-side winding w2 of the transformer 50. Therefore, the sufficient secondary-side voltage can be provided to prevent the unstable output voltage Vo from sudden voltage drop of the input voltage Vi by reducing the turn ratio of the transformer 50, thus stabilizing the output voltage Vo.

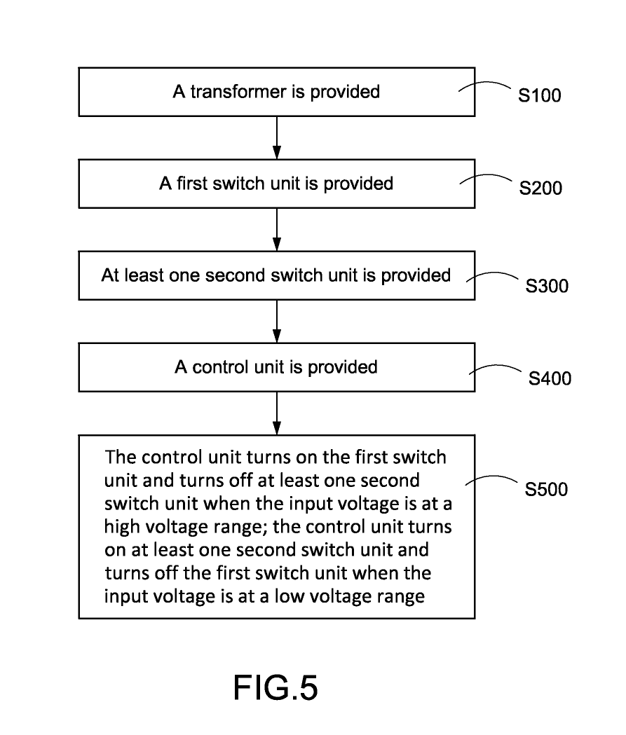

Reference is made to FIG. 5 which is a flowchart of a method of controlling a power converter according to the present invention. The method includes the following steps: A transformer is provided (S100); the transformer has a primary-side winding and a secondary-side winding, wherein the primary-side winding has a first terminal, a second terminal, and at least one tap terminal. A first switch unit is provided (S200); the first switch unit has a first terminal and a second terminal, wherein the first terminal is electrically connected to the second terminal of the primary-side winding; an input voltage is electrically connected between the first terminal of the primary-side winding and the second terminal of the first switch unit. At least one second switch unit is provided (S300); at least one second switch unit has a first terminal and a second terminal, wherein the first terminal is electrically connected to the tap terminal of the primary-side winding and the second terminal is electrically connected to the second terminal of the first switch unit. A control unit is provided (S400). The control unit turns on the first switch unit and turns off at least one second switch unit when the input voltage is at a high voltage range; the control unit turns on at least one second switch unit and turns off the first switch unit when the input voltage is at a low voltage range (S500) so that a turn ratio of the transformer is adaptively adjusted with variations of the input voltage, thus maintaining the power converter to be operated at a maximum duty cycle to provide optimal conversion efficiency.

In this embodiment, It is assumed that the power converter has one the first switch unit and one the second switch unit, the transformer provides a full-turn-ratio conversion for the input voltage by the first switch unit and provide a part-turn-ratio conversion for the input voltage by the second switch unit. That is, the transformer converts the input voltage according to a proportion between a first turn value and a second turn value when total turns of the primary-side winding are divided into the first turn value and the second turn value by the tap terminal connected to the second switch unit. In other words, the control unit turns on the first switch unit and the turns off the second switch unit when the control unit detects that the input voltage is at a high voltage range so that the turn ratio between the primary-side winding and the secondary-side winding is equal to (n1+n2):1. Accordingly, a relation between the output voltage and the input voltage is:

$$Vo = \frac{Vi}{n 1 + n 2} ;$$

On the other hand, the control unit turns on the second switch unit and turns off the first switch unit when the control unit detects that the input voltage is at a low voltage range so that the turn ratio between the primary-side winding and the secondary-side winding is equal to n1:1. Accordingly, a relation between the output voltage and the input voltage is:

$$Vo = \frac{Vi}{n 1} ;$$

Accordingly, the control unit turns on/off the first switch unit and the second switch unit to adaptively adjust a turn ratio between the primary-side winding and the secondary-side winding of the transformer when the power converter detects variations of the input voltage, thus maintaining the power converter to be operated at a maximum duty cycle (refer to formula 2 in description of related art) to provide optimal conversion efficiency.

In this embodiment, It is assumed that the power converter has one the first switch unit and two the second switch units which are referred to the second switch unit and a third switch unit, respectively. Therefore, the transformer provides a full-turn-ratio conversion for the input voltage by the first switch unit and the transformer provides a part-turn-ratio conversion for the input voltage by the second switch unit and the third switch unit. That is, the transformer converts the input voltage according to a proportion between a first turn value, a second turn value, and a third turn value when total turns of the primary-side winding are divided into the first turn value, the second turn value, and the third turn value by the tap terminal connected to the second switch unit and another tap terminal connected to the third switch unit. In other words, the control unit turns on the first switch unit and turns off the second switch unit and the third switch unit when the control unit detects that the input voltage is at a high voltage range so that the turn ratio between the primary-side winding and the secondary-side winding is equal to (n1+n2+n3):1. Accordingly, a relation between the output voltage and the input voltage is:

$$Vo = \frac{Vi}{n 1 + n 2 + n 3} ;$$

Further, the control unit turns on the second switch unit and turns off the first switch unit and the third switch unit when the control unit detects that the input voltage is at a middle voltage range so that the turn ratio between the primary-side winding and the secondary-side winding is equal to (n1+n2):1. Accordingly, a relation between the output voltage and the input voltage is:

$$Vo = \frac{Vi}{n 1 + n 2} ;$$

On the other hand, the control unit turns on the third switch unit and turns off the first switch unit and the second switch unit when the control unit detects that the input voltage is at a low voltage range so that the turn ratio between the primary-side winding and the secondary-side winding is equal to n1:1. Accordingly, a relation between the output voltage and the input voltage is:

$$Vo = \frac{Vi}{n 1} ;$$

Accordingly, the control unit turns on/off the first switch unit, the second switch unit, and the third switch unit to adaptively adjust a turn ratio between the primary-side winding and the secondary-side winding of the transformer when the power converter detects variations of the input voltage, thus maintaining the power converter to be operated at a maximum duty cycle (refer to formula 2 in description of related art) to provide optimal conversion efficiency.

In conclusion, the present invention has following advantages:

1. The turn ratio of the transformer 50 is adaptively adjusted with variations of the input voltage Vi by controlling the first switch unit 10 and the second switch unit 20 by the control unit 40, thus maintaining the power converter to be operated at a maximum duty cycle to provide optimal conversion efficiency; and

2. The sufficient secondary-side voltage can be provided to prevent the unstable output voltage Vo from sudden voltage drop of the input voltage Vi by reducing the turn ratio of the transformer 50, thus stabilizing the output voltage Vo.

Although several embodiments of the present invention have been described in detail, it will be understood that the disclosure is not limited to such details. Various substitutions will occur to those of ordinary skill in the art of the foregoing description. Therefore, all such substitutions and modifications are intended to be embraced within the scope of this disclosure.

What is claimed is:

1. A power converter comprising:
a transformer having a primary-side winding and a secondary-side winding, wherein the primary-side winding has a first terminal, a second terminal, and at least one tap terminal;
a first switch unit having a first terminal and a second terminal, wherein the first terminal is electrically connected to the second terminal of the primary-side winding; an input voltage is electrically connected between the first terminal of the primary-side winding and the second terminal of the first switch unit;
at least one second switch unit having a first terminal and a second terminal, wherein the first terminal is electrically connected to the tap terminal of the primary-side winding and the second terminal is electrically connected to the second terminal of the first switch unit;
a control unit controlling the first switch unit and the second switch unit according to magnitude of the input voltage;
wherein the control unit is configured to turn on the first switch unit and to turn off at least one second switch unit when the input voltage is at a high voltage range; the control unit is configured to turn on at least one second switch unit and to turn off the first switch unit when the input voltage is at a low voltage range;
whereby a turn ratio of the transformer is adaptively adjusted with variations of the input voltage.

2. The power converter in claim 1, wherein the transformer is configured to provide a full-turn-ratio conversion for the input voltage by the first switch unit and the transformer is configured to provide a part-turn-ratio conversion for the input voltage by the second switch unit when the amount of the first switch unit and that of the second switch unit are both equal to one.

3. The power converter in claim 2, wherein the transformer is configured to convert the input voltage according to a proportion between a first turn value and a second turn value when total turns of the primary-side winding are divided into the first turn value and the second turn value by the tap terminal connected to the second switch unit.

4. The power converter in claim 2, wherein the control unit is configured to synchronously and complementarily control the first switch unit and the second switch unit, whereby the first switch unit is turned on when the second switch unit is turned off and the first switch unit is turned off when the second switch unit is turned on.

5. The power converter in claim 1, wherein the transformer is configured to provide a full-turn-ratio conversion for the input voltage by the first switch unit and the transformer provides a part-turn-ratio conversion for the input voltage by these second switch units when the amount of the first switch unit is equal to one and the amount of the second switch unit is equal to two.

6. The power converter in claim 5, wherein the transformer is configured to convert the input voltage according to a proportion between a first turn value, a second turn value, and a third turn value when total turns of the primary-side winding are divided into the first turn value, the second turn value, and the third turn value by the two tap terminals connected to the two second switch units, respectively.

7. The power converter in claim 5, wherein the control unit is configured to synchronously and complementarily control the first switch unit and the two second switch units; whereby the first switch unit is turned on when the two second switch units are turned off; one second switch unit is turned on when the first switch unit and the other second switch unit are turned off; and the other second switch unit is turned on when the first switch unit and one second switch unit are turned off.

8. A method of controlling a power converter; steps of the method comprising:
(a) providing a transformer; the transformer has a primary-side winding and a secondary-side winding, wherein the primary-side winding has a first terminal, a second terminal, and at least one tap terminal;
(b) providing a first switch unit; the first switch unit has a first terminal and a second terminal, wherein the first terminal is electrically connected to the second terminal of the primary-side winding; an input voltage is electrically connected between the first terminal of the primary-side winding and the second terminal of the first switch unit;
(c) providing at least one second switch unit; at least one second switch unit has a first terminal and a second terminal, wherein the first terminal is electrically connected to the tap terminal of the primary-side winding and the second terminal is electrically connected to the second terminal of the first switch unit;
(d) providing a control unit; and
(e) turning on the first switch unit and turning off at least one second switch unit by the control unit when the input voltage is at a high voltage range; turning on at least one second switch unit and turning off the first switch unit by the control unit when the input voltage is at a low voltage range; whereby a turn ratio of the transformer is adaptively adjusted with variations of the input voltage.

9. The method of controlling the power converter in claim 8, wherein the transformer is configured to provide a full-turn-ratio conversion for the input voltage by the first switch unit and the transformer is configured to provide a part-turn-ratio conversion for the input voltage by the second switch unit when the amount of the first switch unit and that of the second switch unit are both equal to one.

10. The method of controlling the power converter in claim 9, wherein the transformer is configured to convert the input voltage according to a proportion between a first turn value and a second turn value when total turns of the primary-side winding are divided into the first turn value and the second turn value by the tap terminal connected to the second switch unit.

11. The method of controlling the power converter in claim 9, wherein the control unit is configured to synchronously and complementarily control the first switch unit and the second switch unit; whereby the first switch unit is turned on when the second switch unit is turned off and the first switch unit is turned off when the second switch unit is turned on.

12. The method of controlling the power converter in claim 8, wherein the transformer is configured to provide a full-turn-ratio conversion for the input voltage by the first switch unit and the transformer provides a part-turn-ratio conversion for the input voltage by these second switch units when the amount of the first switch unit is equal to one and the amount of the second switch unit is equal to two.

13. The method of controlling the power converter in claim 12, wherein the transformer is configured to convert the input voltage according to a proportion between a first turn value, a second turn value, and a third turn value when total turns of the primary-side winding are divided into the first turn value, the second turn value, and the third turn value by the two tap terminals connected to the two second switch units, respectively.

14. The method of controlling the power converter in claim 12, wherein the control unit is configured to synchronously and complementarily control the first switch unit and the two second switch units; whereby the first switch unit is turned on when the two second switch units are turned off; one second switch unit is turned on when the first switch unit and the other second switch unit are turned off; and the other second switch unit is turned on when the first switch unit and one second switch unit are turned off.
